(19) United States
(12) Patent Application Publication
(10) Pub. No.: US 2012/0046974 A1
(43) Pub. Date: Feb. 23, 2012

(54) Unemployment Insurance Underwriting System

(75) Inventors: Robert H. Eshleman, Charlotte, NC (US); Robert M. Mauldin, III, Charlotte, NC (US); Allan S. Voltz, III, Greensboro, NC (US); Jeffrey H. Bierer, Charlotte, NC (US)

(73) Assignee: BANK OF AMERICA CORPORATION, Charlotte, NC (US)

(21) Appl. No.: 12/861,499

(22) Filed: Aug. 23, 2010

(51) Int. Cl. G06Q 40/00; G06Q 90/00; G06Q 30/00

(52) U.S. Cl. 705/4; 705/500

(57) ABSTRACT

Embodiments of the invention include systems, methods, and computer-program products that provide for a unique unemployment insurance underwriting system. In one embodiment of the invention, the unemployment insurance underwriting system receives a request to enroll in the unemployment insurance from a user. The system then receives data associated with the user from a financial institution. The system then determines the benefits to be paid to the user based, in some cases, on the data received from the financial institution. The system then determines whether the user qualifies to enroll in the unemployment insurance based on the benefits and the user data. In an embodiment of the invention, the unemployment insurance provides benefits for monthly expenses to users that have become involuntarily unemployed.

### FIELD

Embodiments of the invention relate generally to unemployment insurance systems and methods and/or other insurance systems and methods.

### BACKGROUND

Currently, financial institutions provide financial services for customers. Financial institutions are also searching for ways to provide enhanced services for their customers, including those customers most in need. When a customer becomes unemployed, financial institutions can provide services to support the customer during the period of unemployment.

Customers are searching for guarantees against financial risk that leverage their relationship with a financial institution to protect them against damage to their lifestyle. Customers and financial institutions are aware that unemployment is high at times and that many customers could not pay their bills more than one month if unemployed. In fact, people generally are looking for new insurance policies against an uncertain employment climate. However, financial institutions are hesitant to offer unemployment insurance because of the risk that customers will make fraudulent claims or have too high a risk of becoming unemployed. An unemployment insurance product offered to inappropriate customers or one that allows inappropriate customers to enroll in the insurance product would be non-sustainable. Financial institutions may desire to offer the unemployment insurance product as a service to their customers but cannot overcome the increased risk when inappropriate customers enroll in the product.

### BRIEF SUMMARY

Embodiments of the present invention address these problems and/or other problems with an innovative insurance system and method. More particularly, a financial institution is often in a unique position to market appropriate insurance products to customers and underwrite those products. The financial institution has detailed income and/or expense information related to a variety of customers that allows them to market and underwrite customized insurance products to appropriate customers. As such, disclosed herein are systems, methods, and computer program products for providing insurance products, such as involuntary unemployment insurance. For example, a method for marketing an unemployment insurance product is disclosed that allows a provider to offer unemployment insurance to qualified customers based on comparison of selection criteria with customer data. In another embodiment of the invention, a method of underwriting an unemployment insurance product is disclosed that allows the provider to determine whether a customer qualifies for the unemployment insurance product based on customer data and the benefits, premium, and terms of the insurance product. In some embodiments of the invention, the marketing and/or underwriting is accomplished in conjunction with an online bill pay system.

The following presents a simplified summary of one or more embodiments of the invention in order to provide a basic understanding of such embodiments. This summary is not an extensive overview of all contemplated embodiments of the invention, and is intended to neither identify key or critical elements of all embodiments of the invention, nor delineate the scope of any or all embodiments. Its sole purpose is to present some concepts of one or more embodiments in a simplified form as a prelude to the more detailed description that is presented later.

Embodiments of the present invention include a system of underwriting an unemployment insurance product. The system comprises a computing platform including a processor and memory. The system further includes an underwriting request routine stored in the memory and executable by the processor. The underwriting request routine is configured to receive requests to enroll in the unemployment insurance product. The system further includes an underwriting database stored in memory and configured to receive data from a financial institution. The system also includes an underwriting analysis routine stored in memory and executable by the processor. The underwriting analysis routine is configured to determine the benefits of the unemployment insurance product. Further, the system includes an underwriting qualification routine stored in memory and executable by the processor. The underwriting qualification routine is configured to determine whether the user qualifies for the unemployment insurance product.

In some embodiments of the invention, the system for underwriting an unemployment insurance product further includes an underwriting pricing routine stored in the memory and executable by the processor. The underwriting pricing routine is configured to determine a premium amount for the unemployment insurance based on at least one of the risk that the user will become involuntarily unemployed or the benefits provided by the unemployment insurance product. In another embodiment of the invention, the benefits provided by the unemployment insurance product are associated with the expenses of the user, wherein the expenses are determined from the data received from the financial institution. In a still further embodiment of the invention, the expenses are periodic bills for which an average value is calculated. For example, the periodic bills can include at least one of the utility bills, the housing costs, the insurance premiums, the property taxes, and the mortgage/rental payments of the user. In another embodiment of the invention, the benefits are selected by the user based from predetermined tiers.

In a further embodiment of the invention, the underwriting qualification routine is configured to determine the risk that the user will become involuntarily unemployed and determine whether that risk is acceptable based, at least in part, on the user data and the benefits provided by the unemployment insurance. In some embodiments of the invention, the data are received from an online bill pay system of a financial institution.

Embodiments of the present invention further provide a method for underwriting an unemployment insurance product involving: receiving a request from the user to enroll in the unemployment insurance product; receiving data associated with the user from a financial institution; determining benefits to be paid by the unemployment insurance; and determining whether the user qualifies for the unemployment insurance product. In some embodiments of the invention, the method further includes allowing the user to select the benefits. In further embodiments of the invention, the method is accomplished using a computing device processor.

In still further embodiments of the invention, the method includes customizing the terms of the unemployment insurance for the user. For example, customizing the terms of the unemployment insurance can include one or more of: determining a waiting period after becoming involuntarily unemployed before the user is allowed to make claims; determining a waiting period after purchasing the product before the user is allowed to make claims; determining a reporting period from a claim event after which the user is unable to make claims based on the claim event; or determining an auto-cancel period wherein the unemployment insurance is canceled if the user does not pay for the unemployment insurance during the auto-cancel period.

In some embodiments of the invention, the benefits of the unemployment insurance are determined based at least in part on the expenses of the user, wherein the expenses are determined from the data. For example, the expenses can be periodic bills for which an average value is calculated, such as utility bills, housing costs, insurance premiums, property taxes, and/or mortgage/rental payments. In an embodiment of the invention, the benefits of the unemployment insurance comprise the sum of the average values of the monthly bills.

In another embodiment of the invention, the method further includes determining a premium for the unemployment insurance based on the benefits provided by the unemployment insurance and/or the risk that the user will become unemployed during the coverage period. The risk that the user will become unemployed during the coverage period is determined, in some embodiments of the invention, based on the employment history of the user determined from the data received from the financial institution.

Embodiments of the present invention further provide a computer program product comprising a non-transitory computer readable medium having computer executable program code embodied therein for underwriting an unemployment insurance product. In one embodiment of the invention, the computer-readable medium includes: a first set of codes for causing a computer to receive a request to enroll in the unemployment insurance product from a user; a second set of codes for causing the computer to receive data associated with a user, the data received from a financial institution; a third set of codes for causing the computer to determine the benefits for the user; and a fourth set of codes for causing the computer to determine whether the user qualifies for the unemployment insurance based on the user data and the benefits.

Other aspects and features, as recited by the claims, will become apparent to those skilled in the art upon review of the following non-limited detailed description of the invention in conjunction with the accompanying figures.

### BRIEF DESCRIPTION OF THE DRAWINGS

Having thus described embodiments of the invention in general terms, reference will now be made to the accompanying drawings, wherein:

FIG. 1 is a flow chart of a method for marketing an unemployment insurance product to a user, in accordance with some embodiments of the invention;

FIG. 2 is a flow chart of a method for marketing modifications to an unemployment insurance product to a user, in accordance with some embodiments of the invention;

FIGS. 3 and 4 are a flow chart of a method for underwriting an unemployment insurance product to a user, in accordance with some embodiments of the invention;

FIG. 5 is a block diagram of an exemplary system for marketing and/or underwriting an unemployment insurance product, in accordance with some embodiments of the invention; and

FIG. 6 is an example of a commercial embodiment of the method and system for marketing an unemployment insurance product through an online bill pay system, in accordance with some embodiments of the invention.

### DETAILED DESCRIPTION OF EMBODIMENTS OF THE INVENTION

Embodiments of the present invention now will be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

As will be appreciated by one of ordinary skill in the art in view of this disclosure, the present invention may be embodied as an apparatus (including, for example, a system, machine, device, computer program product, and/or the like), as a method (including, for example, a business process, computer-implemented process, and/or the like), or as any combination of the foregoing. Embodiments of the present invention are described below with reference to flowchart illustrations and/or block diagrams of such methods and apparatuses. It will be understood that blocks of the flowchart illustrations and/or block diagrams, and/or combinations of blocks in the flowchart illustrations and/or block diagrams, can be implemented by computer-executable program instructions (i.e., computer-executable program code). These computer-executable program instructions may be provided to a processor of a general purpose computer, special purpose computer, or other programmable data processing apparatus to produce a particular machine, such that the instructions, which execute via the processor of the computer or other programmable data processing apparatus, create a mechanism for implementing the functions/acts specified in the flowchart and/or block diagram block or blocks. As used herein, a processor may be “configured to” perform a certain function in a variety of ways, including, for example, by having one or more general-purpose circuits perform the function by executing one or more computer-executable program instructions embodied in a computer-readable medium, and/or by having one or more application-specific circuits perform the function.

These computer-executable program instructions may be stored or embodied in a computer-readable medium to form a computer program product that can direct a computer or other programmable data processing apparatus to function in a particular manner, such that the instructions stored in the computer readable memory produce an article of manufacture including instructions which implement the function/act specified in the flowchart and/or block diagram block(s).

Any combination of one or more computer-readable media/medium may be utilized. In the context of this document, a computer-readable storage medium may be any medium that can contain or store data, such as a program for use by or in connection with an instruction execution system, apparatus, or device. The computer-readable medium may be a transitory computer-readable medium or a non-transitory computer-readable medium.

A transitory computer-readable medium may be, for example, but not limited to, a propagation signal capable of carrying or otherwise communicating data, such as computer-executable program instructions. For example, a transitory computer-readable medium may include a propagated data signal with computer-executable program instructions embodied therein, for example, in base band or as part of a carrier wave. Such a propagated signal may take any of a variety of forms, including, but not limited to, electro-magnetic, optical, or any suitable combination thereof. A transitory computer-readable medium may be any computer-readable medium that can contain, store, communicate, propagate, or transport program code for use by or in connection with an instruction execution system, apparatus, or device. Program code embodied in a transitory computer-readable medium may be transmitted using any appropriate medium, including but not limited to wireless, wired, optical fiber cable, radio frequency (RF), etc.

A non-transitory computer-readable medium may be, for example, but not limited to, a tangible electronic, magnetic, optical, electromagnetic, infrared, or semiconductor storage system, apparatus, device, or any suitable combination of the foregoing. More specific examples (a non-exhaustive list) of the non-transitory computer-readable medium would include, but is not limited to, the following: an electrical device having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

It will also be understood that one or more computer-executable program instructions for carrying out operations of the present invention may include object-oriented, scripted, and/or unscripted programming languages, such as, for example, Java, Perl, Smalltalk, C++, SAS, SQL, Python, Objective C, and/or the like. In some embodiments of the invention, the one or more computer-executable program instructions for carrying out operations of embodiments of the present invention are written in conventional procedural programming languages, such as the “C” programming languages and/or similar programming languages. The computer program instructions may alternatively or additionally be written in one or more multi-paradigm programming languages, such as, for example, F#.

The computer-executable program instructions may also be loaded onto a computer or other programmable data processing apparatus to cause a series of operation area steps to be performed on the computer or other programmable apparatus to produce a computer-implemented process such that the instructions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

Embodiments of the present invention may take the form of an entirely hardware embodiment of the invention, an entirely software embodiment (including firmware, resident software, micro-code, etc.), or an embodiment combining software and hardware aspects that may generally be referred to herein as a “module,” “application,” or “system.”

It should be understood that terms like “bank,” “financial institution,” and “institution” are used herein in their broadest sense. Institutions, organizations, or even individuals that process financial transactions are widely varied in their organization and structure. Terms like financial institution are intended to encompass all such possibilities, including but not limited to banks, finance companies, stock brokerages, credit unions, savings and loans, mortgage companies, insurance companies, and/or the like. Additionally, disclosed embodiments may suggest or illustrate the use of agencies or contractors external to the financial institution to perform some of the calculations, data delivery services, and/or authentication services. These illustrations are examples only, and an institution or business can implement the entire invention on their own computer systems or even a single work station if appropriate databases are present and can be accessed.

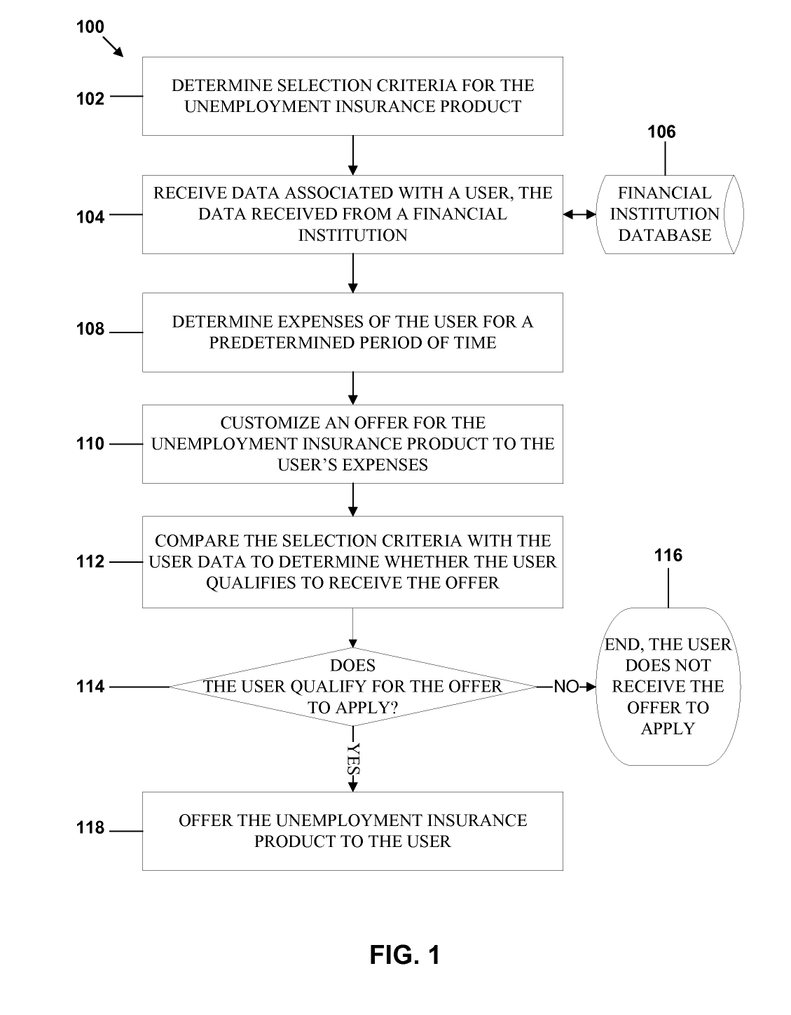

As illustrated in FIGS. 1-6, aspects of the present disclosure include methods, systems, and computer program products directed to an unemployment insurance product, such as an involuntary unemployment insurance product. In an exemplary embodiment of the invention, the unemployment insurance pays benefits directly to a user if the user becomes involuntarily unemployed during the policy term. In one embodiment of the invention, the methods, systems, and computer program products are directed to marketing of an unemployment insurance product. In another embodiment of the invention, the methods, systems, and computer program products are directed to underwriting of an unemployment insurance product. It will be appreciated that, although embodiments of the present invention are generally described herein in the context of unemployment insurance, other embodiments of the invention may be adapted to create, market, or underwrite other types of insurance.

In one embodiment of the invention, an unemployment insurance marketing system provides systems and methods of marketing an insurance product to appropriate users. An unemployment insurance marketing system allows a bank to provide a service to the bank's customers by offering a useful, and in some cases customized, insurance product to appropriate users. For example, the bank is able to determine selection criteria for the unemployment insurance product, receive data associated with a user from a financial institution database, compare the selection criteria with the user data, and if the user qualifies to receive an offer, offer the unemployment insurance product to the user. In another example, the bank is able to determine the user's monthly expenses based on data in an online bill pay system and customize the offer for the unemployment insurance product based on the user's expenses. Determination of selection criteria, types of data received, and customization procedures using the unemployment insurance marketing system is discussed in more depth below with regard to FIGS. 1-6.

FIG. 1 is a flow chart of an example of a method 100 for creating and maintaining an unemployment insurance marketing system in accordance with an embodiment of the present invention. In block 102, the provider determines selection criteria for the unemployment insurance product. In an embodiment of the invention, the selection criteria determine whether a user will receive an offer to apply for the unemployment insurance. For example, the selection criteria may be determined based on those likely to apply, those likely to be approved, or those likely to enroll in the unemployment insurance. The selection criteria may be based on characteristics of the user, such as whether the user has a primary relationship with the bank. In other examples, the selection criteria may exclude users from receiving an offer based on one or more of an income source, an expense, a minimum balance in one or more accounts, the length of time that the user has been a customer of the bank, whether the user has direct deposit or online bill pay accounts, or any other characteristics of the user.

In one embodiment of the invention, the selection criteria are determined based on a model created using transaction data from a financial institution. The model evaluates users to determine which users are likely to enroll in the unemployment insurance and/or likely to become involuntarily unemployed during the coverage period of the unemployment insurance. For example, the model may determine that users residing in a specific region or working in a specific field have a higher than average likelihood of becoming involuntarily unemployed in the next six months. In this example, the selection criteria are determined to exclude these users from receiving an offer. Conversely, the model may determine that customers working for a single employer for an extended period of time, such as five years, may have a lower than average likelihood of becoming involuntarily unemployed in the next six months. The model may then determine selection criteria so that these customers receive an offer to apply. In this example, the length of employment can be determined based on direct deposit information with the bank.

In another embodiment of the invention, the selection criteria are determined by a financial institution. In another embodiment of the invention, the selection criteria are determined by a third party, such as an insurance underwriter. The selection criteria can change over time. For example, the selection criteria can become more stringent so that fewer people receive an offer when the unemployment rate increases nationally or regionally. In a further embodiment of the invention, the selection criteria may differ for different regions. For example, a region having low unemployment may have less stringent criteria, resulting in more users receiving offers, than a region having high unemployment and more stringent criteria. In an exemplary embodiment of the invention, the selection criteria are determined so that users that receive offers are likely to accept the offers and also likely to remain employed during the coverage period. In another embodiment of the invention, the selection criteria are determined so that if a user meets the criteria, the user is automatically qualified for the unemployment insurance and can enroll in the unemployment insurance product without applying further.

Turning now to block 104, data associated with a user is received from a financial institution. In one embodiment of the invention, the data are transactional data. For example, the data may include the amount of income and expenses over time. The data may also include employer name, payee name, balance information, types of accounts, or any other information available to the financial institution.

In an embodiment of the invention, the user in block 104 is a customer of the financial institution. For example, the customer may have a primary relationship with the financial institution meaning that the customer has direct deposit of wages with the financial institution and uses the checking and/or savings account at the financial institution as the primary account for everyday transactions. In another embodiment of the invention, the user is a potential customer or associated with a customer of the financial institution. For example, the user may be the primary wage earner for a family, for whom unemployment insurance would be a prudent decision.

In block 104, the data are received from a financial institution. The data may be received electronically or in hard copies. In an exemplary embodiment of the invention, the data are received from a database, as depicted in block 106. For example, the database may be a database associated with a financial institution, such as an online bill pay database. It should be understood that the data can be received from a financial institution and/or database in a variety of ways and the aforementioned examples are not limiting.

Turning now to block 108, in some embodiments of the invention the expenses for the user are determined for a predetermined period of time. In an embodiment of the invention, the expenses are recurring bills for the user, such as mortgage payments, utility bills, loan payments, and insurance premiums. If the user becomes unemployed, it may be difficult for the user to continue to pay these expenses.

The expenses can be determined in a variety of ways. In an embodiment of the invention, the expenses are determined from financial transactions at the financial institution. For example, recurring payments to the same payee may be evaluated, automatically or manually, to determine if the payments are user expenses. Historical transaction data including payments and transfers from one or more accounts held at the financial institution or linked to the financial institution may be evaluated to determine the user's expenses. Average expenses may be calculated over six months, a year, or any other time period available for bills that vary, such as electricity bills. In another embodiment of the invention, the expenses are determined using an online bill pay system. In a still further embodiment of the invention, various expenses including housing payments, utility bills, loans, and insurance premiums can be aggregated to determine an aggregate amount of the user's expenses.

In block 108, the expenses are determined for a predetermined period of time, such as for a month, a quarter, six months, a year, or for any other period of time. In an exemplary embodiment of the invention, the predetermined period of time would equal the payment periods for the unemployment insurance. For example, if the unemployment insurance pays benefits monthly, the user's expenses would be determined on a monthly basis.

In block 110, an offer for the unemployment insurance product is customized to the user's expenses. In an embodiment of the invention, the offer is customized by offering an unemployment insurance product with benefits that would be sufficient to cover the user's expenses if the user becomes unemployed. For example, if the user has monthly expenses that total $1000, the offer can be for unemployment insurance product that has a monthly benefit of at least $1000. In another embodiment of the invention, the offer is customized to each expense. For example, the offer can include reference to the user's actual mortgage payment, utility payments, and insurance premium payments. In a still further embodiment of the invention, the offer indicates that if the user becomes involuntarily unemployed, the insurance product can automatically and directly pay the user's qualified expenses during the coverage period, thus providing the user peace of mind during a stressful period.

Turning now to block 112, in some embodiments of the invention the selection criteria are compared with the user data to determine whether the user qualifies to receive an offer. In an embodiment of the invention, the selection criteria are compared with the user data using a computing device processor. By comparing the user data to the selection criteria, the users that qualify to receive an offer are separated from the users that do not qualify. In an embodiment of the invention, financial institution customers are evaluated on a continuous or intermittent basis to determine if any customers should receive an offer to apply for the unemployment insurance product. In another embodiment of the invention, only a subset of the financial institution's customers is evaluated. For example, the financial institution may determine that it is in violation of government regulations to use customer data to market an insurance product in a certain geographic region. In another example, the financial institution may determine that the risk of involuntary unemployment is too high in another geographic region to offer unemployment insurance to anyone in that state. It should be understood that comparison of the selection criteria with the user data can be accomplished at any frequency and with respect to any group of users.

In decision block 114, the comparison of the selection criteria and the user data results in a determination on whether the user qualifies to receive an offer to apply. If the user does not qualify, the process ends for that user, as depicted in block 116. In an embodiment of the invention, the user can be evaluated at a later date based on a change in the selection criteria, upon the user's request, or for any other reason.

If the user qualifies for an offer based on the comparison, the unemployment insurance product is offered to the user, as depicted in block 118. In some embodiments of the invention, the unemployment insurance product is offered to the user in a browser, such as an Internet browser or any browser on an operating system. In an exemplary embodiment of the invention, the unemployment insurance product is offered through a financial institution's online bill pay system. Other embodiments include offering the unemployment insurance product on an ATM, an electronic bulletin board, a personal digital assistant (PDA), smartphone, computer, mobile telecommunications device, an alerting device (e.g., a pager), or other electronic device. Further, portions of the unemployment insurance system can be presented to the user via a user's mobile device (e.g., PDA, mobile phone, etc.), via an email message, Short Messaging Service (SMS) text message, Multimedia Messaging Service (MMS) text message, a wireless networked connection, a telephone call to the user, a voice message, or any other method of presenting information to the user. Further, the unemployment insurance product can be offered to the user through the mail, on the user's account statements, or in person. The unemployment insurance product can be offered to the user in a visual format, audibly, any combination thereof or by any other method. It should be understood that a variety of ways of offering the unemployment insurance product to the user are well within the scope of the present invention, and the previously-mentioned examples and embodiments are not intended to limit the method of offering the unemployment insurance product.

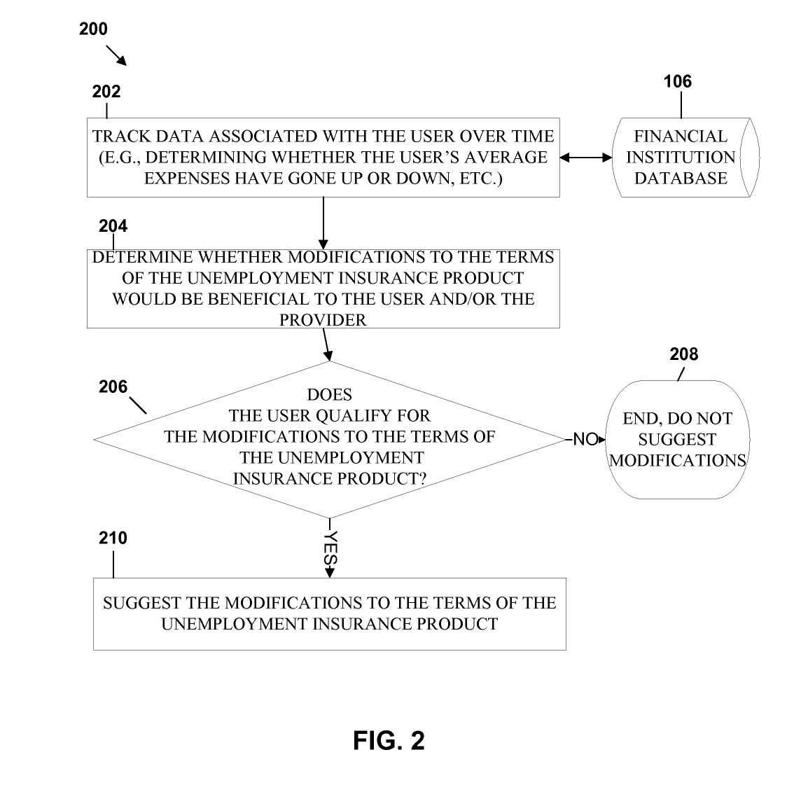

Turning now to FIG. 2, a method 200 of marketing modifications in the unemployment insurance product is presented, in accordance with an embodiment of the present invention. In some embodiments of the invention, a user enrolled in the unemployment insurance product may benefit by modifications to the terms of the product. For example, a user's monthly expenses may have increased so that the benefits provided by the unemployment insurance would not cover them. In this example, the user may wish to modify the terms of the unemployment insurance product to increase the benefit level. The method 200 of marketing modifications in the unemployment insurance product provides a service to users by tracking the user's expenses over time, evaluating whether modifications to the unemployment insurance would benefit the user and/or the financial institution, determining whether the user qualifies for modifications to the unemployment insurance, and offering the modifications to the unemployment insurance to the user.

In block 202, the provider of the unemployment insurance product tracks data associated with an enrolled user over time. For example, the provider can track data to determine whether the user's average expenses have gone up or down. In an embodiment of the invention, the provider tracks the user data using a financial institution database 106. For example, the provider may track the user's expenses in connection with an online bill pay system. In another example, the provider tracks the user expenses through transactions in checking and/or savings accounts. In another embodiment of the invention, the provider tracks data associated with the user's employment situation. For example, the provider may determine that the user has changed employers, that the user has moved to a new location but remained with the same employer, or that the user has received a promotion. In a still further embodiment of the invention, the provider tracks data associated with the user's employer. For example, a financial institution may be able to determine that the user's employer is conducting layoffs based on transaction data in the financial institution database. The provider may track the user data on a continuous basis, on an intermittent basis, or any other frequency. The provider may track the user data automatically or upon request of the user. It should be understood that the provider of the unemployment insurance can track data associated with a user in any manner, and that the examples disclosed previously are not intended to limit the invention.

Turning now to block 204, the provider determines whether modifications to the terms of the unemployment insurance would be beneficial to the user and/or the provider. A wide variety of modifications to the unemployment insurance product are possible. In an embodiment of the invention, the modifications relate to the benefits provided by the unemployment insurance should the user become involuntarily unemployed. For example, the user may find it beneficial to increase the benefits provided by the unemployment insurance if the user's average expenses have increased. In another example, the user's average expenses may have decreased and the user would desire to decrease the level of benefits. In a still further example, the provider may desire to lower its potential liability and therefore would want to decrease the benefits available to users.

In another embodiment of the invention, the modifications relate to other terms of the unemployment insurance product. For example, a user changing jobs may find it beneficial to extend the duration of the unemployment insurance product. In another embodiment of the invention, the user may find it beneficial to modify waiting periods associated with the unemployment insurance product. For example, the user may wish to decrease the waiting period before the user is able to make claims after a qualifying event, such as becoming involuntarily unemployed. In another example, the user may desire to extend the reporting period after a qualifying event during which the user is able to make a claim. Other modifications of the terms of the unemployment insurance product are possible.

In decision block 206, the provider determines whether the user qualifies for the modifications to the terms of the unemployment insurance. In an embodiment of the invention, the user is treated as a new user and evaluated to determine if the user would qualify to receive an offer based on the modified terms. For example, the provider could conduct the steps described previously in blocks 102, 104, 112, and 114 for the user based on the modifications to the unemployment insurance. In this example, selection criteria and data associated with the user are compared to determine whether the user should receive an offer to modify the unemployment insurance based on the modifications. In one embodiment of the invention, the modification is an increase in the benefit level paid for a qualifying event. In this embodiment of the invention, the user is evaluated to determine if they could pay the premium for that benefit level and if their risk of unemployment is acceptable for that benefit level, for example.

If the user does not qualify for the modifications to the terms of the unemployment insurance the process ends, as depicted in block 208. The modifications are not suggested or offered to the user. If, however, the user does qualify for the modifications then the modifications are suggested or offered to the user, as depicted in block 210. As described above with regard to block 118, the provider may offer the modifications to the user in a variety of ways. For example, the provider may offer the modifications via mail, via e-mail, on a statement, in person, over the phone, through an Internet browser, through an online bill pay system, or in any other manner the provider uses to communicate with the user.

In an embodiment of the invention, the provider charges a fee to modify the terms of the unemployment insurance product. The fee may be a lump sum to change the policy or it may be an amount that is added to the premium for the policy. In another embodiment of the invention the provider modifies the terms of the unemployment insurance product for free.

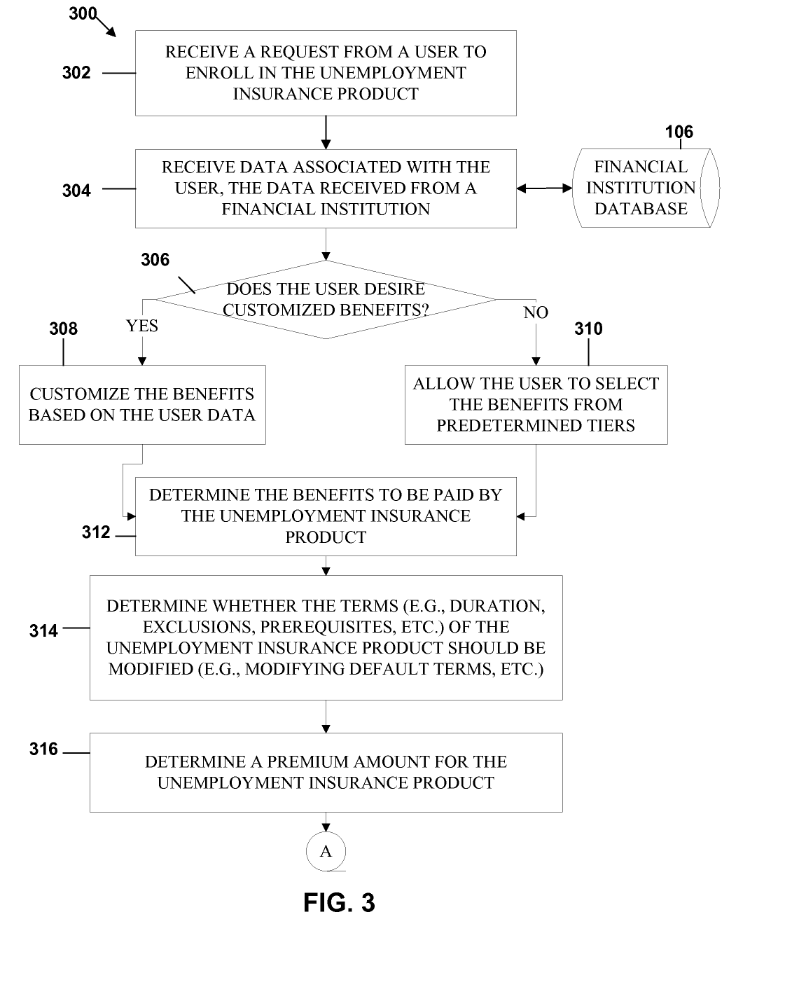

In FIG. 3, a method 300 for underwriting an unemployment insurance product is provided. In an embodiment of the invention, the method 300 includes receiving a request from a user to enroll in the unemployment insurance product or to modify terms to the unemployment insurance product. The method further includes receiving data associated with the user from a financial institution and determining benefits to be paid by the unemployment insurance product. In addition the method includes determining whether the user qualifies for the unemployment insurance product.

For example, if a financial institution receives a request from a customer to enroll in an unemployment insurance product, the financial institution can receive information on the customer's income and expenses from an online bill pay system. Based on that information, the financial institution can determine the appropriate level of benefits for the unemployment insurance. In this example, the appropriate level of benefits may be a level determined based both on what the customer can afford to pay and what the customer's expenses are. After determining the benefits to be paid to the customer, the financial institution can determine if the customer qualifies for the unemployment insurance. This may entail evaluating the customer's work history, credit score, income, and expenses. Finally, the financial institution enrolls the customer if the customer qualifies based on work history, credit score, and/or other customer data.

Turning now to block 302, the provider receives a request from a user to enroll in the unemployment insurance product. For example, the request may be an application to enroll in the unemployment insurance product. In an embodiment of the invention, the provider receives the request in response to an offer to enroll in unemployment insurance. In another embodiment of the invention, the provider receives the request independently from the user. In a further embodiment of the invention, the provider receives the request from the user over the Internet. For example, the provider may receive the request through a webpage, through an online application form, through an online bill pay system, or through an email. In another embodiment of the invention, the provider receives the request from the user in person, over the phone, or through the mail.

In an embodiment of the invention, the request includes data associated with the user. For example, the request may include the user's income, the user's education and/or employment history, the user's age, or other information related to qualifying for the unemployment insurance. In another embodiment of the invention, the request includes a desired level of benefits for the unemployment insurance. For example, the user may request benefits in the amount customized for the user as shown and described in relation to block 110 of FIG. 1. In another example, the user may request a larger or smaller benefit amount. In another embodiment of the invention, the benefit amount is based on predetermined tiers, such as $1000/month, $3000/month, $5000/month, or the like.

As discussed previously, in an embodiment of the invention the unemployment insurance product provides benefits for a predetermined period of time if the user becomes involuntarily unemployed. For example, the benefits may be directly deposited in the user's account or a check may be sent to the user. In another embodiment of the invention, the benefits are paid directly to the user's creditors. For example, if one of the user's expenses is a mortgage payment, the unemployment insurance may be able to, directly and automatically, pay the mortgage lender if the user becomes unemployed. In an exemplary embodiment of the invention, the benefits are paid through the online bill payment system so that no interruption in the payment process occurs.

Turning now to block 304, the provider receives data associated with the user. In an embodiment of the invention, the provider receives the data from a financial institution database, as depicted in block 106. The financial institution database may be a financial transactions database, an online bill pay database, or any other type of database associated with a financial institution. The provider receives the data electronically or in hard copy. In another embodiment of the invention, the provider receives the data directly from the user. For example, the user may fill out an application that provides income and expense information along with any other qualifying information necessary to apply for the unemployment insurance product.

In an embodiment of the invention, the data are financial transaction data and/or demographic data. In one embodiment of the invention, the financial transaction data are determined from a checking account, savings account, or online bill pay system. For example, a financial institution may receive data related to a customer's bills by identifying payments to creditors based on payee name. The provider may identify mortgage lenders, electric utilities, and student loan payments by predetermined payee names. In another example, the financial institution identifies creditors by the relative frequency or amount of payments. A payment to the same payee every month for approximately the same amount may be a payment to a creditor. In another embodiment of the invention, transaction data are identified as expenses because they have been submitted by the user in an online bill pay system. In a still further embodiment of the invention, the user indicates to the system which data to receive. The user may indicate the data in an online form, through a paper document, verbally, or in any other manner.

Demographic data received by the financial institution may include the user's age, gender, income, career field, homeowner status, length of time employed at the current employer, location, education level, or any other data related to a user and determinable by the provider. For example, a financial institution may determine the length of time that a customer has been employed by a single employer based on payee names of paychecks received in the customer's account. In another example, the financial institution may determine the user's location based on the user's mailing address for statements. In another embodiment of the invention, the demographic data is credit-worthiness data related to the user. For example the financial institution may receive the user's credit score, debt levels, credit limits, and credit history. As should be known, a wide range of demographic data associated with a user can be determined from financial and financial institution-specific data and the examples given here are not intended to be limiting.

In decision block 306, the provider determines whether the user desires customized benefits for the unemployment insurance product. In an embodiment of the invention, the provider determines this based on the information received from the user in the request. In another embodiment of the invention, the provider queries the user to determine if customized or a predetermined benefit tier is desired.

If the user desires customized benefits, the provider customizes the benefits based on the user's expenses, as depicted in block 308. For example, the provider may customize the benefits so that the user's expenses would be covered if the user becomes unemployed. In some embodiments of the invention, the provider automatically calculates the user's expenses based on the data received from the financial institution. For example, a financial institution may determine the expenses for a user by identifying the amount of each monthly expense for the past six months and calculating an average monthly expense. In another example, the benefits are customized for the user by determining the maximum amount for each expense over the past six months and aggregating them to determine a maximum monthly expense. In a still further embodiment of the invention, the provider customizes the user's benefits by using an algorithm that modifies the user's expenses. For example, the provider may determine the user's average expenses over the past six months and then discount them by 20%. In an exemplary embodiment of the invention, the provider customizes the benefits for the user based on expenses determined through an online bill pay system. For example, a financial institution may offer unemployment insurance that covers expenses that are paid through an online bill pay system. It should be understood that the customization of the user's benefits may occur in any manner related to the user's expenses. For example, the median amount of the user's expenses may be used instead of the average amount so that outlying months do not draw the user's expenses up or down.

If, however, the user does not desire customized benefits, the provider allows the user to select a predetermined benefit tier, as depicted in block 310. In an embodiment of the invention, the provider makes available tiered preset amounts for the user to choose from. For example, the provider can offer an unemployment insurance product that pays $1000/month, $3000/month, $5000/month, or the like. In another embodiment of the invention, there is only one preset amount available.

In block 312, the provider determines the benefits to be paid by the unemployment insurance product. In an embodiment of the invention, the provider determines that the benefits customized for the user, as in block 308, or selected by the user, as in block 310 are acceptable for the user. For example, if a user's customized benefits are $1800/month the provider may determine that this is an appropriate level of benefits for that user. The provider may determine that the level is appropriate based on the user's income, length of employment, age, or any other criteria associated with the underwriting process. In another embodiment of the invention, the provider modifies the amount determined in blocks 308 or 310. For example, the provider may determine that the amount customized for the user is too high for the unemployment insurance product. In this example, the provider may determine a lower amount of benefits for the user to be provided.

Turning now to block 314, in some embodiments the provider determines whether the terms of the unemployment insurance product should be modified. For example, the provider may determine that the terms of the unemployment insurance product should be modified to reduce adverse selection of users. Adverse selection of users is when users enroll in the unemployment insurance knowing that they will soon be unemployed. In some situations, users actively bring about their own unemployment in order to collect the unemployment insurance. Adverse selection is an issue in unemployment insurance because it violates the assumption in underwriting that the user does not want to be and is not trying to become unemployed. A variety of means of reducing adverse selection in unemployment insurance are possible by modifying the terms of the unemployment insurance.

In one embodiment of the invention, the terms of the unemployment insurance product require a validation procedure. For example, the provider may have a validation procedure that determines whether the user was let go for cause, colluded with the employer to become unemployed, or voluntarily resigned. In another example, the provider may validate the user's unemployment by checking with the user's employer or checking with government unemployment offices to determine whether the user qualifies for government unemployment. In another embodiment of the invention, the user files for the benefits monthly and must qualify to receive the benefits through the validation procedure each time. The terms may also require that the user actively search for employment during the unemployment period. If they do not search for employment they may be barred from receiving a benefit for that month or they may be excluded from receiving any future benefits.

In another embodiment of the invention, the provider determines a waiting period after becoming involuntarily unemployed before the user is allowed to make claims. By enforcing a waiting period, the provider reduces the chance that a user will file a fraudulent claim because of the lack of an immediate payout. In a still further embodiment of the invention, the provider determines a waiting period after purchasing the unemployment insurance before the user is allowed to make claims. By requiring a waiting period after purchasing the product, the provider reduces adverse selection from users who know that they will soon be laid off. In some embodiments of the invention, the provider determines a reporting period after which user is unable to make a claim based on a qualifying event. For example, the provider may require that users report becoming unemployed within two months of becoming unemployed or be barred from filing a claim on that event. Again, this reduces the chance of fraudulent claims. In a still further embodiment of the invention, the terms may include a 30 day auto cancel period. For example, if a user is 30 days late in paying for the unemployment insurance the policy will be automatically canceled.

In block 316, in some embodiments the provider determines a premium amount for the unemployment insurance product. The premium can be determined based on a single payment, quarterly payments, monthly payments, or any other frequency. In an embodiment of the invention, the premium is determined based on the benefits and/or the user data. The premium can be determined automatically, based on insurance tables, through use of a computer, based on algorithms, or based on any other manner for calculating insurance premiums. The premium can be determined based on what the user is able to pay. In another embodiment of the invention, the premium amount is determined by a third party and provided to the unemployment insurance provider. It should be understood that the premium can be determined in a variety of ways and the examples given herein are but a few examples of how premiums are determined.

In an embodiment of the invention, discounts to the premium are available. For example, if the user pays the premium in a lump sum a discount may be available. Other examples of when discounts are available include when the premium is paid via direct deposit or from an account with the provider, when the user is a member of a preferred group or class, or when the benefits are a certain amount.

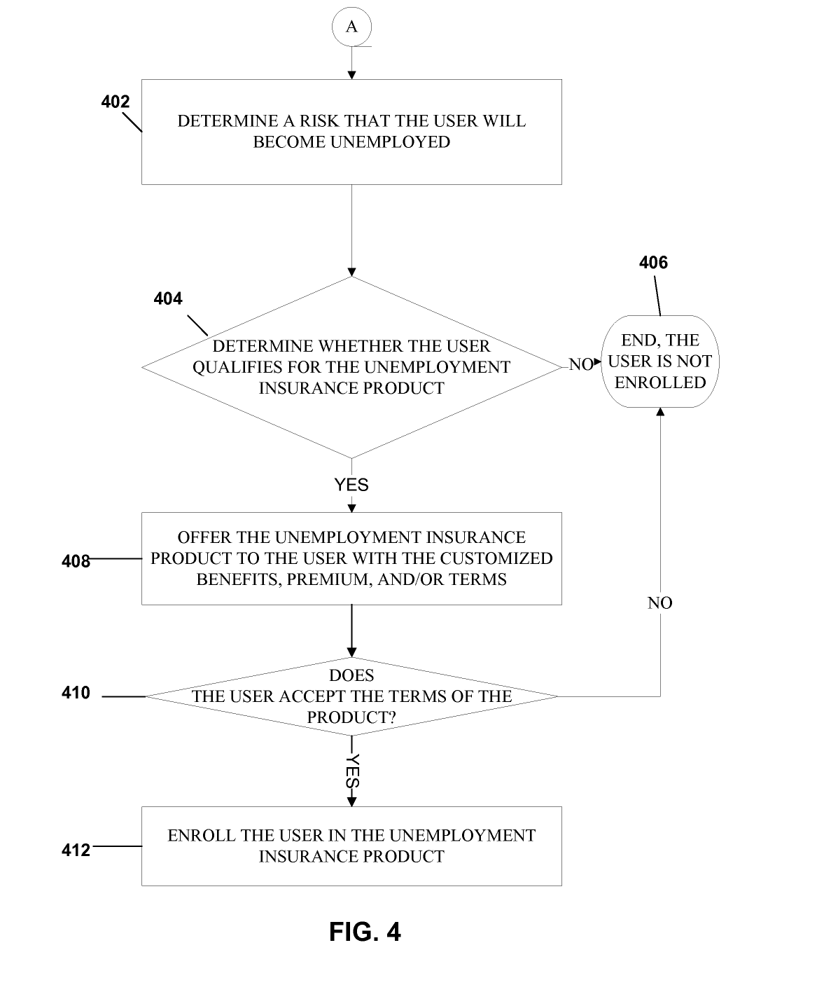

Turning now to FIG. 4, in an embodiment of the invention in block 402, the provider determines a risk that the user will become unemployed. For example, the provider may determine the risk that the user will become involuntarily unemployed. In some embodiments of the invention, the provider determines the risk that the user will become unemployed by evaluating the user's employment history and demographic characteristics. For example, a financial institution may determine how long the user has been employed at the same employer, the user's age, and the user's salary and determine the risk that the user will become unemployed based on a calculation utilizing this information. In another embodiment of the invention, the provider determines the risk that the user will become unemployed by creating a model based on financial institution-specific data. For example, a financial institution may have employment data on a wide range of financial institution customers from transactional account data. Using that data, the financial institution may be able to calculate a possibility that any single customer will become unemployed based on the model. In a still further embodiment of the invention, the provider determines the risk that a user will become unemployed based on financial institution-specific data relating to the user's employer. For example, a financial institution may process the payroll direct deposits for a business's employees. If the financial institution has information indicating that the business is laying off employees or slowing hiring of employees, the financial institution may determine that the risk of unemployment for that business's employees is higher than would be determined based on the user alone. In a still further embodiment of the invention, the provider determines the risk that a user will become involuntarily unemployed based, at least in part, on prevailing regional or national trends. For example, a certain geographic region may have unusually high unemployment levels. In that region, the provider may modify the risk of unemployment determined using any one of the other methods to take into account the regional unemployment rate. These embodiments are but a few of the embodiments illustrating how a provider determines the risk that a user will become unemployed; other embodiments are possible and within the scope of the disclosure herein.

In decision block 404, the provider determines whether the user qualifies for the unemployment insurance product. In an embodiment of the invention, determining whether the user is qualified is the final step in the process of underwriting the insurance. In some embodiments of the invention, determining user qualification includes evaluating the user data, the benefits, the terms, the premium, and/or the risk posed by the user to determine if the user is qualified to enroll in the unemployment insurance. For example, the risk that the user will become involuntarily unemployed may be acceptable but the benefits customized for the user may be too high for the user to qualify.

If the risk is not acceptable, the provider does not enroll the user and the method for underwriting the unemployment insurance ends, as depicted in block 406. In some embodiments of the invention, the user may reapply at some point in the future. For example, the user may reapply after changing jobs into a more stable career field. In other examples, the user may reapply after changing the level of benefits, after a predetermined period of time has passed, or after moving to a new region.

It should be understood that the steps of the method 300 for underwriting an unemployment insurance product can be performed in any order. For example, FIGS. 3 and 4 depict that the premium amount is determined before the risk level of the user is determined. In another embodiment of the invention, the risk level of the user is determined and then the premium amount is determined, which may include the risk level in the determination step. In a further embodiment of the invention, all of the determination steps are completed before the provider determines whether the customer qualifies for the unemployment insurance product.

Turning now to block 408, if the user qualifies for the unemployment insurance product, the user is offered the unemployment insurance with the benefits, premium, and terms determined in the underwriting process. The offer can be in writing, electronically, or verbally. The offer can be transmitted to the user over the Internet, such as through a web browser or email, through the mail, via a fax, in person, or in any other manner of communicating with the user. In an exemplary embodiment of the invention, the provider offers the unemployment insurance with the benefits, premium, and terms through an online bill payment system.

In decision block 410, the provider determines whether the user accepts the unemployment insurance with the offered benefits, premium, and terms. The provider can determine this in writing, by e-signature, verbally, or in any other way that the provider can receive assent from the user. In an embodiment of the invention, this determination is made by signing an acknowledgment of the terms and conditions of the insurance and/or paying the first installment of the premium.

If the user does not accept the benefits, premium, and terms offered by the provider, the process ends and the user is not enrolled in the unemployment insurance, as depicted in block 406. As previously, in some embodiments the user can reapply, request reconsideration, or adjust the desired benefit level. The user may also be able to reapply after a predetermined period of time has passed or after a predetermined condition has occurred, such as changing of unemployment, reaching a certain number of years with a single employer, or moving to a new region.

If, however, the user accepts the offered benefits, premium, and terms, the provider enrolls the user in the unemployment insurance, in an embodiment depicted in block 412. In this embodiment of the invention, the user is enrolled for a predetermined period of time, such as six months or a year, and must re-qualify at the end of each period. In another embodiment of the invention, the user is automatically re-enrolled in the unemployment insurance at the end of the period unless the user opts out of re-enrollment or would not qualify at that time. For example, if a user is enrolled in the unemployment insurance for a six month period and voluntarily leaves his employer at the end of the six month period, the user would not qualify to automatically re-enroll in the unemployment insurance.

The unemployment insurance system is created to perform the above-described methods. Embodiments of the unemployment insurance system (or portions thereof) can market and underwrite the unemployment insurance product to appropriate users, as previously discussed. For example, when logging into an online bill pay system, the user can view a customized unemployment insurance offer, apply for the insurance, and enroll in the insurance so that the user's monthly expenses are covered should the user become involuntarily unemployed.

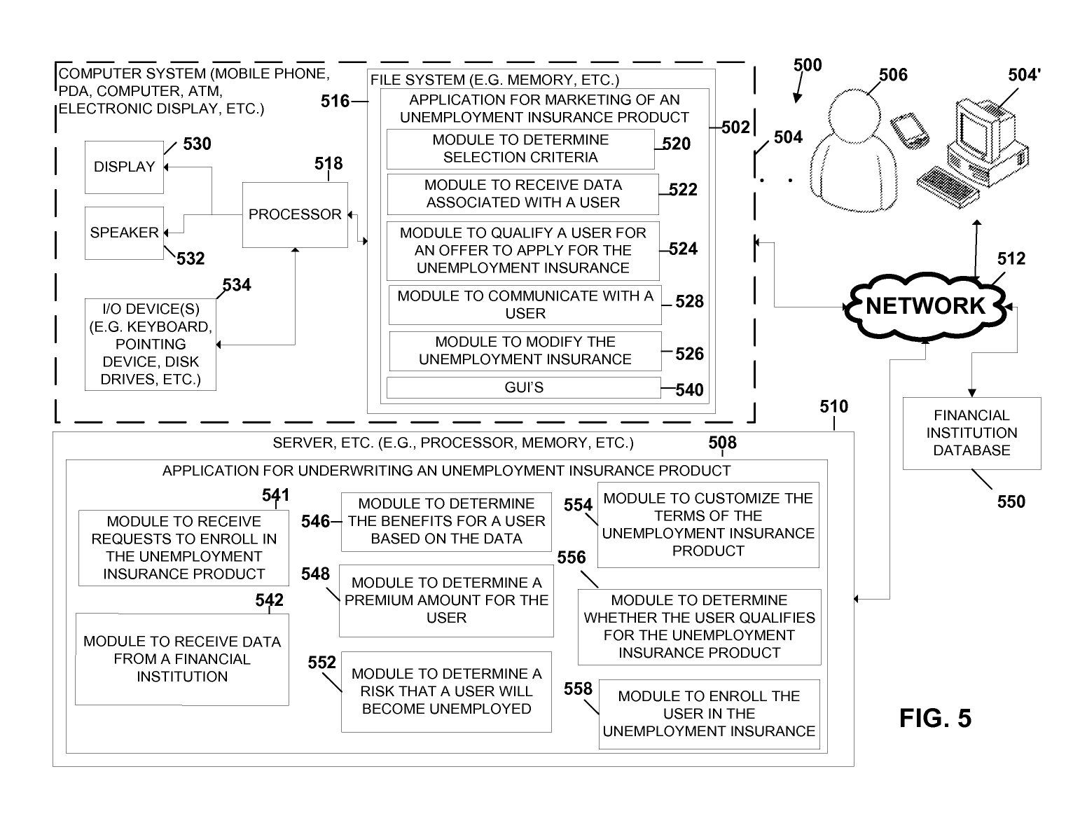

Alternatively or additionally, some embodiments of the unemployment insurance system (or portions thereof) can receive user data, determine whether the user qualifies to receive an offer or to enroll in the unemployment insurance, and offer or enroll the user in the unemployment insurance. The offers and the product may be personalized for the user of the content based on financial institution-specific data about the user. The components and operations of some embodiments of the system are described below with regard to FIG. 5.

FIG. 5 is a block schematic diagram of an example of a system 500 for an unemployment insurance system in accordance with some embodiments of the invention. The system 500 includes an unemployment insurance marketing application (“marketing application”) 502 operable on a computer system 504 or similar device of a user 506 or a client 504′. In some embodiments of the invention, some or all of the marketing application 502 is downloaded to or otherwise stored on the user's computer system 504 as shown in FIG. 5, however, in other embodiments of the invention, some or all of the marketing application 502 resides on a server 510 and is accessed by the computer system 504 using a browser application, such as a web browser, stored in the computer's memory 516.

In addition to the marketing application 502 on the user's computer system 504 or client 504′, the system 500 includes an unemployment insurance underwriting application (“underwriting application”) 508 operable on the server 510 and accessible by the user 506 or client 504′ via a network 512. The previously discussed methods 100-300 are embodied or performed by the marketing application 502 or the underwriting application 508. For example, the methods 100-200 may be performed by the marketing application 502. In another embodiment of the invention, the methods 100-300 are performed by the underwriting application 508. In a further embodiment of the present invention, some of the features or functions of the methods 100-300 are performed by the marketing application 502 on the user's computer system 504 and other features or functions of the methods 100-300 are performed on the underwriting application 508.

The network 512 is the Internet, a private network, or other network. Each computer system 504 is similar to the exemplary computer system 504 and associated components as illustrated in FIG. 5.

The marketing application 502 and/or underwriting application 508 is a self contained system with imbedded logic, decision making, state based operations and other functions that operate an unemployment insurance system.

The marketing application 502 is stored on a file system 516 or memory of a computer system 504. The marketing application 502 may be accessed from the file system 516 and run on a processor 518 associated with the computer system 504.

The marketing application 502 includes a selection criteria module 520. The selection criteria module 520 allows for determination of the selection criteria for receiving an offer. In an embodiment of the invention, the selection criteria module 520 is accessed or activated whenever the user 506 logs into a user account or an online bill pay system of the financial institution.

The marketing application 502 also includes a data receiving module 522. At this point, the user information is transmitted from a financial institution database 550 via the network 512. The data received can include financial transaction and/or demographic data related to the user. The data receiving module 522 allows the marketing application 502 to receive information from the financial institution database 550 for comparison with the selection criteria.

The marketing application 502 also includes an offer qualification module 524. The offer qualification module 524 compares the selection criteria with the user data to determine whether the user qualifies to receive an offer. The offer qualification module 524 can also communicate with the underwriting application 508 to evaluate whether the user is likely to be approved for the unemployment insurance.

The marketing application 502 includes a modification module 528. The modification module 528 determines whether the user and/or the provider would benefit from modification to the terms of the unemployment insurance. The modification module 528 interacts with the financial institution database 550 to determine if the user's expenses have changed compared to the benefit level of the unemployment insurance. If the expenses have changed, the modification module 528 is able to offer modifications to the unemployment insurance so that the user is fully covered should he become unemployed. In another embodiment of the invention, the modification module 528 communicates with the underwriting application 508 to determine whether the user would have originally qualified to enroll in the unemployment insurance under the modified terms.

Marketing application 502 includes a communication module 526. The communication module 526 allows for communicating an offer to the user and receiving the user's response. In an embodiment of the invention, the communication module 526 communicates the offer in conjunction with an online bill pay system or webpage associated with the financial institution.

The user's computer system 504 includes a display 530 and speaker 532. Any graphical user interfaces 540 associated with the marketing application 502 is presented on the display 530. The user's computer system 504 also includes one or more input devices, output devices or combination input and output devices, collectively I/O devices 534. The I/O devices 534 includes a keyboard, computer pointing device, touch screen, touch pad, or similar devices to control input of information as described herein. The I/O devices 534 also include disk drives or devices for reading computer media including computer readable or computer operable instructions.

The underwriting application 508 includes an enrollment request module 541. The enrollment request module 541 performs functions related to receiving a request to enroll in the unemployment insurance product from the user 506. In an embodiment of the invention, the enrollment request module 541 receives information in response to an offer made by the marketing application 502. The enrollment request module 541 links the underwriting application 508 on the server 510 to modules on the user's computer 504 and internal data sources, such as a financial institution database 550.

The underwriting application 508 also includes a data receiving module 542. The data receiving module 542 receives data from the financial institution database 550 relating to the user 506. In an embodiment of the invention, the data receiving module 542 also receives data associated with the user from the communication module 526 of the marketing application 502. For example, the data receiving module 542 may receive data relating to the user's identity from the communication module 526 and use the user's identity to collect data related to the user from a variety of financial transaction data sources in the financial institution database 550.

The underwriting application 508 additionally includes a benefit determination module 546. The benefit determination module 546 determines the level of benefits offered by the unemployment insurance for the user. In an embodiment of the invention, the benefits are customized for the user based on the user's expenses. For example, the benefit determination module 546 may communicate with the financial institution database 550 to determine an average or maximum level of expenses for the user. In another embodiment of the invention, the benefit determination module 546 determines tiered levels of benefits for the user. In a still further embodiment of the invention, the benefit determination module 546 receives data from the user through the communication module 526 of the marketing application 502 and evaluates the benefits requested by the user to determine if they are appropriate.

The underwriting application 508 additionally includes a premium determination module 548. The premium determination module 548 determines the premium for the unemployment insurance based on the user data, the risk posed by the user, and/or the benefits paid by the unemployment insurance. The premium can be determined automatically or manually. The premium determination module 548 allows the underwriting application 508 to determine a customized premium for a user based on the customized unemployment insurance. In an embodiment of the invention, the premium determination module 548 also determines whether the premium is to be paid by direct deposit from the user's accounts.

The underwriting application 508 also includes a risk determination module 552. The risk determination module 552 determines the risk that a user will become unemployed during the coverage period. The risk determination module 552 may determine the risk based on user data, based on model created using financial institution and/or online bill pay data, or based on a third party calculation of risk levels. The risk determination module 552 interacts with other modules, such as the financial institution database 550 and the data receiving module 542.

The underwriting application 508 also includes a customization module 554. The customization module 554 customizes of the terms of the unemployment insurance for the user. In an embodiment of the invention, the customization module 554 customizes the terms to reduce adverse selection. The customization module 504 communicates with the financial institution database 550 and the data receiving module 542 to determine whether the terms should be customized for the user.

The underwriting application 508 also includes an enrollment qualification module 556. The enrollment qualification module 556 and determines whether the user qualifies to enroll in the unemployment insurance. In an embodiment the enrollment qualification module 556 considers the benefit level, the user data, the premium amount, the customized terms, and the risk that the user will become unemployed to determine whether the user qualifies. The enrollment qualification module 556 communicates with other modules in the underwriting application 508, such as the risk determination module 552, the premium determination module 548, the customization module 554, and the data receiving module 542 to determine whether the user qualifies. In an embodiment of the invention, the enrollment qualification module 556 also communicates with the user using the communication module 526 through the network 512 to gather additional information that may be necessary to determine whether the user qualifies. For example, the enrollment qualification module 556 may determine that additional information relating to the user's employment is necessary and query the user to receive that information before qualifying the user.

The underwriting application 508 also includes an enrollment module 558. The enrollment module 558 enrolls users in the unemployment insurance if the enrollment qualification module determines that the users qualify to enroll in the unemployment insurance. In an embodiment of the invention, the enrollment module 558 enrolls users after the user has accepted the customized benefits, premium, and terms of the unemployment insurance. The enrollment module 558 communicates with the user via the communication module 526 to receive information regarding the user's enrollment in the unemployment insurance.

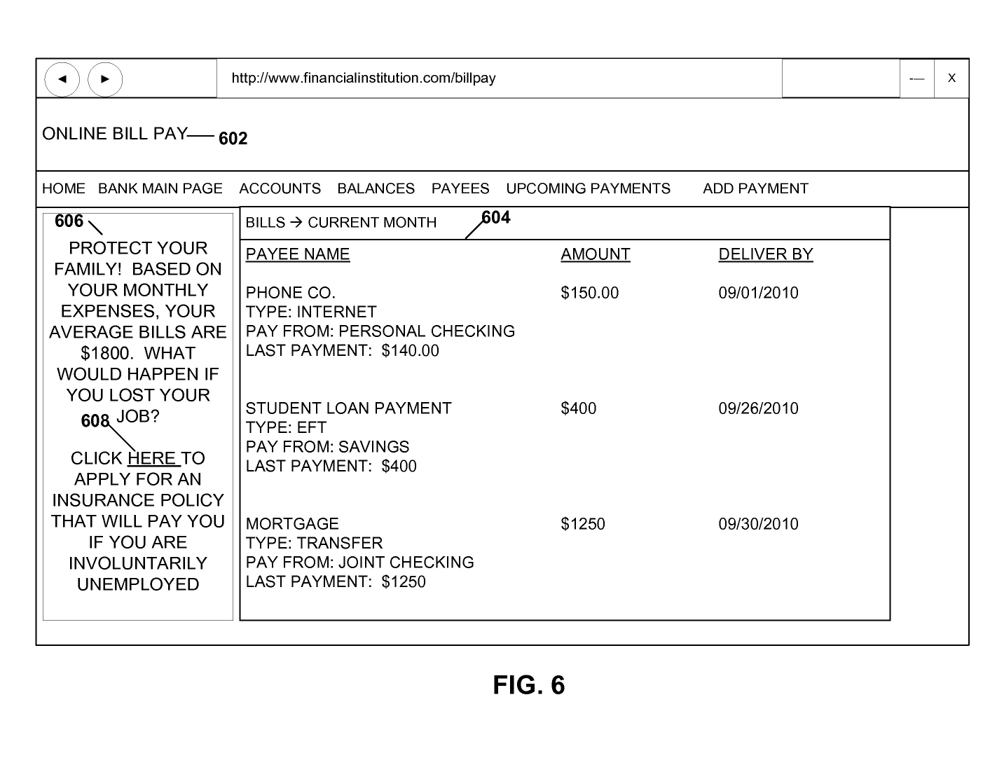

FIG. 6 is an exemplary embodiment of an unemployment insurance system presented to a user in accordance with the embodiments of the invention described above with regard to FIGS. 1-5. The method of marketing unemployment insurance 600 is illustrated as displayed on an online bill pay system 602. The online bill pay system 602 provides a method of determining the user's expenses 604. After determining the user's expenses, a provider is able to customize an offer 606 of unemployment insurance for the user. In some embodiments of the invention, the offer 606 can provide an immediate link 608 for the user to apply for the unemployment insurance. The method of marketing unemployment insurance 600 described and illustrated in FIG. 6 is only meant to be directed to some embodiments and other embodiments are within the scope of the present invention based on the disclosure provided herein.

The flowcharts and block diagrams in the figures illustrate the architecture, functionality, and operation of possible implementations of apparatuses, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, functions repeated by the two blocks shown in succession may, in fact, be executed substantially concurrently, or the functions noted in the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer-executable instructions.

The terminology used herein is for the purpose of describing particular embodiments only and is not intended to be limiting of the invention unless the context clearly indicates otherwise. As used herein, the singular forms “a,” “an,” and “the” are intended to include the plural forms as well, unless the context clearly indicates otherwise. It will be further understood that the terms “includes,” “has,” “comprises,” “including,” having,” and/or “comprising,” when used in this specification, specify the presence of stated features, integers, steps, operations, elements, and/or components in the stated embodiment of the invention, but do not preclude the presence or addition of one or more other features, integers, steps, operations, elements, components, and/or groups thereof.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, combinations, and modifications of the just described embodiments can be configured without departing from the scope and spirit of the invention. Therefore, it is to be understood that, within the scope of the appended claims, the invention may be practiced other than as specifically described herein.

What is claimed is:

1. A method of underwriting an unemployment insurance product, the method comprising:
receiving, at a computing device, a request from a user to enroll in the unemployment insurance product, wherein the unemployment insurance product provides benefits for a predetermined period of time if the user becomes involuntarily unemployed;
receiving data associated with the user from a financial institution;
determining benefits to be provided by the unemployment insurance; and
determining, via a computing device processor, whether the user qualifies for the unemployment insurance product.

2. The method of claim 1, further comprising determining a premium amount for the unemployment insurance based on at least one of a risk that the user will become involuntarily unemployed and the benefits provided by the unemployment insurance product.

3. The method of claim 1, wherein determining benefits further comprises determining the benefits based at least in part on expenses of the user, wherein the expenses are determined from the data.

4. The method of claim 3, wherein determining benefits further comprises determining the benefits based at least in part on the expenses of the user, wherein the expenses are periodic bills for which an average value is calculated.

5. The method of claim 4, wherein the determining benefits further comprises determining the benefits based at least in part on the expenses, wherein the expenses are the periodic bills and wherein the periodic bills comprise at least one of utility bills, housing costs, insurance premiums, property taxes, and loan payments.

6. The method of claim 1, wherein determining benefits further comprises determining the benefits, wherein the benefits are selected by the user based on predetermined tiers.

7. The method of claim 1, wherein the determining, via a computing device processor, whether the user qualifies for the unemployment insurance product comprises:
determining a risk that the user will become involuntarily unemployed; and
determining whether the risk is acceptable based, at least in part, on the user data and the benefits provided by the unemployment insurance.

8. The method of claim 1, wherein receiving further comprises receiving the data from an online bill pay system of a financial institution.

9. A method of underwriting an unemployment insurance product, the method comprising:
receiving a request from a user to enroll in the unemployment insurance product, wherein the unemployment insurance product provides benefits for a predetermined period of time if the user becomes involuntarily unemployed;
receiving data associated with the user from a financial institution;
determining benefits to be provided by the unemployment insurance; and
determining whether the user qualifies for the unemployment insurance product.

10. The method of claim 9, further comprising allowing the user to select the benefits.

11. The method of claim 9, further comprising customizing the terms of the unemployment insurance for the user.

12. The method of claim 11, wherein the customizing the terms of the unemployment insurance comprises at least one of:
determining a waiting period after becoming involuntarily unemployed before the user is allowed to make claims;
determining a waiting period after purchasing the product before the user is allowed to make claims;
determining a reporting period from a claim event after which the user is unable to make claims based on the claim event; and
determining an auto-cancel period wherein the unemployment insurance is automatically cancelled if the user does not pay for the unemployment insurance during the auto-cancel period.

13. The method of claim 9, wherein the determining the benefits comprises determining a sum of average values for monthly bills of the user based on the data provided by the financial institution.

14. The method of claim 9, further comprising determining a premium for the unemployment insurance based on at least one of the benefits provided by the unemployment insurance or a risk that the user will become involuntarily unemployed.

15. The method of claim 14, wherein the risk that the user will become involuntarily unemployed during the coverage period is based, at least in part, on an employment history of the user, wherein the employment history is determined based on the data received from the financial institution.

16. A system for underwriting an unemployment insurance product, the system comprising:
a computing platform including a processor and a memory;
an underwriting request routine stored in the memory, executable by the processor and configured to receive requests to enroll in the unemployment insurance product, wherein the unemployment insurance product provides benefits to pay for expenses for a predetermined period of time for the user if the user becomes involuntarily unemployed;
an underwriting database stored in the memory and configured to receive data from a financial institution;
an underwriting analysis routine stored in the memory, executable by the processor and configured to determine benefits to be provided by the unemployment insurance product; and
an underwriting qualification routine stored in the memory, executable by the processor and configured to determine whether the user qualifies for the unemployment insurance product.

17. The system of claim 16, further comprising an underwriting pricing routine stored in the memory, executable by the processor and configured to determine a premium amount for the unemployment insurance based on at least one of a risk that the user will become involuntarily unemployed and the benefits provided by the unemployment insurance product.

18. The system of claim 16, wherein the benefits are associated with the expenses of the user, the expenses determined from the data.

19. The system of claim 16, wherein the expenses are periodic bills for which an average value is calculated.

20. The system of claim 19, wherein the periodic bills comprise at least one of utility bills, housing costs, insurance premiums, property taxes, and loan payments.

21. The system of claim 19, wherein the benefits are selected by the user based on predetermined tiers.

22. The system of claim 16, wherein the underwriting qualification routine is configured to determine a risk that the user will become involuntarily unemployed; and determine whether the risk is acceptable based, at least in part, on the user data and the benefits provided by the unemployment insurance.

23. The system of claim 16, wherein the data are received from an online bill pay system of a financial institution.

24. A computer program product for underwriting an unemployment insurance product, the computer program product comprising:
a computer-readable medium comprising:
a first set of codes for causing a computer to receive a request to enroll in the unemployment insurance product, wherein the unemployment insurance product provides benefits to pay for expenses for a predetermined period of time for the user if the user becomes involuntarily unemployed;
a second set of codes for causing a computer to receive data from a financial institution;
a third set of codes for causing a computer to determine benefits to be provided by the unemployment insurance product; and
a fourth set of codes for causing a computer to determine whether the user qualifies for the unemployment insurance product.

25. The computer program product of claim 24, further comprising a set of codes for causing a computer to determine a premium amount for the unemployment insurance based on at least one of a risk that the user will become involuntarily unemployed and the benefits provided by the unemployment insurance product.

26. The computer program product of claim 24, wherein the benefits are associated with the expenses of the user, the expenses determined from the data.

27. The computer program product of claim 24, wherein the expenses are periodic bills for which an average value is calculated.

28. The computer program product of claim 27, wherein the periodic bills comprise at least one of utility bills, housing costs, insurance premiums, property taxes, and loan payments.

29. The computer program product of claim 27, wherein the benefits are selected by the user based on preset levels.

30. The system of claim 24, wherein the fourth set of codes causes a computer to determine a risk that the user will become involuntarily unemployed; and determine whether the risk is acceptable based, at least in part, on the user data and the benefits provided by the unemployment insurance.

31. The system of claim 24, wherein the data are received from an online bill pay system of a financial institution.
